(19) United States
(12) Patent Application Publication
(10) Pub. No.: US 2005/0239395 A1
(43) Pub. Date: Oct. 27, 2005

(54) Method for providing a set of basic services for using a telecommunicaiton network

(76) Inventors: Gerard Delegue, Cachan (FR); Helene Papini, Orsay (FR)

Correspondence Address: SUGHRUE MION, PLLC, 2100 PENNSYLVANIA AVENUE, N.W., SUITE 800, WASHINGTON, DC, 20037, US

(21) Appl. No.: 10/522,801

(22) PCT Filed: Jul. 11, 2003
(86) PCT No.: PCT/FR03/02198

§ 371 Date: Mar. 1, 2005

(30) Foreign Application Priority Data
Aug. 1, 2002 (US) 2009816

(51) Int. Cl. H04K 3/00

(52) U.S. Cl. 455/1

(57) ABSTRACT

The invention concerns a method for providing a set of elementary services for use in a telecommunication network which, in mutual combination, constitute batches of services. It comprise the following steps: forming groups (123, 45) of elementary services (14, 24, 34₁, 35₁), and activating or deactivating the services of a common group during a common transaction such tat all the services of a group can be activated only when all the other elementary services of that group are capable of being activated. Preferably, when an elementary service becomes unavailable, the elementary services pertaining to the same group(s) as the unavailable elementary service are rendered inactive unless they also pertain to another group of elementary services and the elementary services forming that other group of elementary services are activated.

The present invention relates to a method of providing a set of basic services for using a telecommunication network and to a server for implementing that method.

Telecommunication operators often propose bundles of services for using their networks. These bundles of services, which will be referred to hereinafter as “high-level services”, are made up of basic services. The basic services and the high-level services are generally defined in service level specifications (SLS), referred to hereinafter, for simplicity, as “service specifications”. The information contained in a service specification comprises, for example, the date of activation of the service and quality of service parameters such as the maximum bit rate and availability of the transmission channel. Accordingly, in certain cases, the specification of a high-level service corresponds to a technical transcription of the requirements of the service provider's client.

Telecommunication network service providers often propose a range of bundles of services constituting various combinations of the available basic services. In this way these service providers are best able to respond to the requirements of their clients.

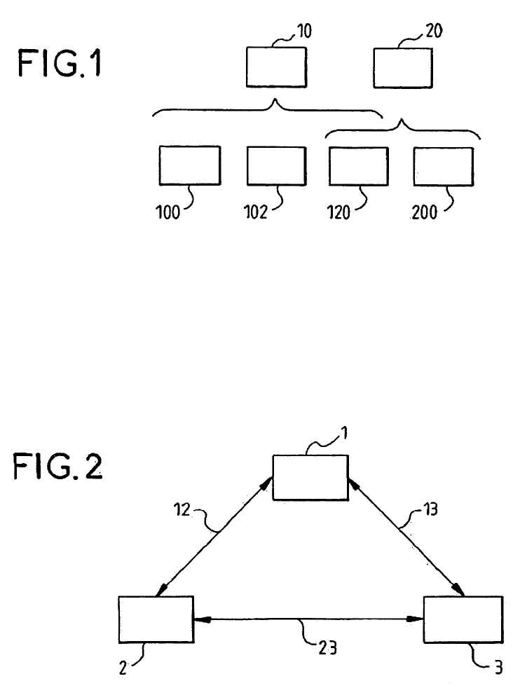

FIG. 1 is a diagram of one example of a set of basic services 100, 102, 120, 200 that are combined to form bundles 10 and 20 of services.

The invention stems from the following observations:

Certain of the basic services constituting a bundle of services can sometimes not be activated at a given time, for example because certain resources of the telecommunication network, such as a server, are unavailable because of a fault or a maintenance operation. The service provider must then decide whether to activate the other basic services that constitute the high-level service.

In certain cases, a high-level service subscriber receives no service from his service provider, even if the latter is in a position to provide him with a partial service.

In other cases, certain basic services prove to be indispensable for the functioning of a high-level service, with the result that the high-level service cannot be provided if any of the basic services is unavailable, even if all the other basic services are activated. In this case, the activation of the other basic services that constitute the high-level service leads to wasteful mobilization of resources, since the high-level service cannot be provided.

To illustrate some of the current drawbacks that have been mentioned, FIG. 2 represents a high-level service that consists in networking three sites 1, 2 and 3 of a business, for example in an IP virtual private network (IP-VPN). The high-level service is made up of basic services which in this instance are logical links 12, 13 and 23 between the various sites of the business. In a first situation, for them to function, the sites 1 and 2 need to exchange data via the logical link 12. The site 3 requires either the logical link 13 and the site 1 to be functioning or the logical link 23 and the site 2 to be functioning. If the logical link 12 is unavailable, the two sites 1 and 2 cannot function and consequently neither can the site 3. In this case, if the service provider activates the logical links 13 and 23, even though the logical link 12 is deactivated, he immobilizes resources wastefully. In another situation, the site 1 needs to exchange data over the logical links 12 and 13 with the sites 2 and 3. However, the site 1 can operate a reduced service by exchanging data only with the site 3. In this case, it would be beneficial, in the event of unavailability of the logical link 12, for the business to have access to the logical link 13 in order for the reduced service to function.

The present invention remedies the drawbacks mentioned above.

It consists in a method of providing a set of basic services for using a telecommunication network which, combined with each other, constitute bundles of services, which method is characterized in that it comprises the following steps:
groups of basic services are constituted, and
the services of the same group are activated or deactivated during the same transaction so that the basic services of a group can be activated only if all the other basic services of that group can be activated.

In practice, the groups of basic services that constitute a high-level service are defined by the provider of the high-level service or by the subscriber to the high-level service.

The term “transaction” means a set of operations whose effects are produced only if all the operations of the set succeed. Thus activation of the various basic services of the same group occurs only if all the basic services of that group can be activated.

The invention avoids wasteful mobilization of resources because, when at least one of the basic services is unavailable, none of the other basic services of the same group is activated.

Furthermore, the fact that one of the basic services cannot be activated is reflected in non-activation of the group or groups to which it belongs, but not by non-activation of the high-level service in its entirety. In this way, partial service may be provided. The provider does not deliver a complete service, but does provide at least a portion of the service.

In one embodiment of the invention, when a basic service becomes unavailable, the basic services belonging to the same group or groups as the basic service that has become unavailable are rendered inactive unless they also belong to another group of basic services such that all the basic services that constitute that other group of basic services are activated.

The present invention therefore applies equally if a basic service becomes unavailable when already activated.

In one embodiment, a group identifier is assigned to each of the basic services of a group, this group identifier being a simple code or a list of the basic services that form part of the group, for example.

The group identifier is preferably such that two different groups of basic services are associated with two different identifiers.

In one embodiment, the identifier associated with a group of basic services is stored in each of the specifications of the basic services that constitute the group of basic services. If a basic service belongs to a plurality of groups, the specification of that basic service contains as many different identifiers as there are different groups to which the basic service belongs.

In one embodiment all the identifiers of the groups of basic services that constitute a high-level service are stored in the specification of that high-level service.

The invention also consists in a server comprising means for commanding the activation or deactivation of the basic services, taking into account, especially, the resources available on the telecommunication network, the specification of the high-level service to be provided, the specifications of the basic services which constitute said high-level service and the activatable or active state of the basic services on the telecommunication network. The server comprises means for activating and deactivating basic services such that the basic services such that the basic services of the same group of basic services are activated or deactivated during the same transaction, and such that the basic services of the same group can be activated only if all the other basic services of that group can be activated.

Finally, the invention further consists in a telecommunication server comprising means for deactivating basic services of a telecommunication network, these basic services forming groups. When at leat one of the said basic services from a group of basic services, becomes unavailable, said telecommunication server is such that during the same transaction it deactivates all the services from the group of basic services which do not also belong to at least one other group of basic services whose basic services are active.

Other features and advantages of the invention will become apparent from the following description of certain embodiments thereof given way of non-limiting example and with reference to the appended drawings, in which:

FIG. 1, already described, is a diagram of a set of basic services combined to form bundles of services,

FIG. 2, already described, is a diagram of a high-level service networking three sites,

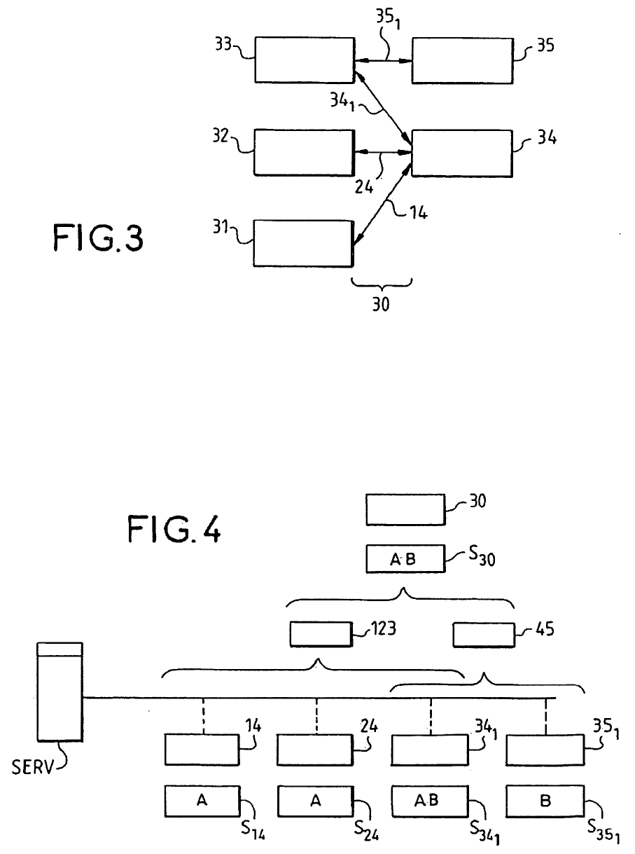

FIG. 3 is a diagram of a high-level service networking five sites, and

FIG. 4 is a diagram of the application of the method of the invention.

FIG. 3 is a diagram of an IP virtual private network (IP-VPN) corresponding to a high-level service 30 that connects five sites 31, 32, 33, 34 and 35 by means of logical link services 14, 24, 34₁ and 35₁.

The sites 31, 32 and 35 are autonomous: they can function independently of the state of the various logical connection services. On the other hand, for them to function, the site 33 requires to be connected to the sites 34 and 35 and the site 34 requires to be connected to the sites 31, 32 and 33.

FIG. 4 illustrates the interdependence of the services. The basic services 14, 24 and 34₁ belong to one group 123 of basic services and the basic services 34₁ and 35₁ belong to another group 45 of basic services.

All these basic services constitute the high-level service 30.

The activation and deactivation of the basic services are commanded by the server SERV. The group 123 is assigned an identifier A and the group 45 is assigned an identifier B.

Finally, the basic services 14, 24, 34₁ and 35₁ are defined by specifications S14, S24, S34₁ and S35₁ and the high-level service 30 is defined by a specification S30 containing the identifiers A and B.

The specifications S14, S24 and S34₁ define the basic services of the group 123 or contain the identifier A of the group 123. Similarly, the specifications S34₁ and S35₁ defining the basic services of the group 45 contain the identifier B of the group 45. Because the basic service 34₁ belongs to both groups 123 and 45, its specification S34₁ contains the identifiers A and B of both those groups.

To activate the high-level service 30, the server SERV commands activation of the basic services 14, 24, 34₁ and 35₁. If it is impossible to activate the logical connection 24 (for example because of a fault), during a first transaction, the server SERV activates neither the logical connection 14 which, like the logical link 24, belongs to the group 123 and to no other group, nor the logical connection 34₁, for the same reason.

During a second transaction, given that the two basic services 34₁ and 35₁ of the group 45 can be activated, the server SERV commands the activation of the two services 34₁ and 35₁. Accordingly, in this example, a partial service is provided despite the unavailability of the basic service 24, and resources such as the logical connection 14 are not mobilized wastefully.

1. Method of providing a set of basic services for using a telecommunication network which, combined with each other, constitute bundles of services, which method is characterized in that it comprises the following steps:
groups (123, 45) of basic services (14, 24, 34₁, 35₁) are constituted, and
the services of the same group are activated or deactivated during the same transaction so that the basic services of a group can be activated only if all the other basic services of that group can be activated.

2. Method according to claim 1 characterized in that when a basic service becomes unavailable, the basic services belonging to the same group or groups as the basic service that has become unavailable are rendered inactive unless they also belong to another group of basic services such that all the basic services that constitute that other group of basic services are activated.

3. Method according to claim 1 characterized in that each of the basic services of a group is assigned a group identifier.

4. Method according to claim 3 characterized in that the identifier of a group of basic services is stored in the specifications of all the basic services belonging to that group.

5. Server comprising means for providing a set of basic services for using a telecommunication network which, combined with each other, constitute bundles of services, which server is characterized in that, the basic services being combined into groups of basic services,
it comprises means for activating or deactivating the services of the same group during the same transaction, and
it comprises means so that the transaction is such that the basic services of a group can be activated only if all the other basic services of that group can be activated.

6. Server comprising means for deactivating basic services of a telecommunication network which, combined with each other, constitute bundles of services, which server is characterized in that, the basic services being combined into groups of basic services, it comprises means for deactivating, during the same transaction, if at least one of said basic services of a group of basic services becomes unavailable, all the services of the group of basic services that do not also belong to at least one other group of basic services such that all the basic services that constitute that other group of basic services are activated.
